(19) United States
(12) Patent Application Publication
(10) Pub. No.: US 2025/0159640 A1
(43) Pub. Date: May 15, 2025

(54) ELECTRONIC DEVICE AND CONTROLLING METHOD THEREOF

(71) Applicant: SAMSUNG ELECTRONICS CO., LTD., Suwon-si (KR)

(72) Inventor: Seongil HAHM, Suwon-si (KR)

(73) Assignee: SAMSUNG ELECTRONICS CO., LTD., Suwon-si (KR)

(21) Appl. No.: 18/999,511

(22) Filed: Dec. 23, 2024

Related U.S. Application Data
(63) Continuation of application No. PCT/KR2023/011520, filed on Aug. 4, 2023.

(30) Foreign Application Priority Data
Sep. 29, 2022 (KR) 10-2022-0124711

(51) Int. Cl. H04W 60/00; G16Y 10/75; H04W 48/16; H04W 88/06

(52) U.S. Cl. CPC H04W 60/00; H04W 48/16; G16Y 10/75; H04W 88/06

(57) ABSTRACT

An electronic device includes a first communication device to perform communication through a first wireless communication scheme, a second communication device to perform communication through a second wireless communication scheme which is different from the first wireless communication scheme, and a processor to control the first communication device such that device information is received from an Internet of Things (IoT) device that is unregistered, and the processor is configured to, based on device information of the IoT device being received through the first wireless communication scheme, control the second communication device to broadcast, through the second wireless communication scheme, notification information including the device information and notifying that there is the IoT device that is unregistered.

This application is a continuation application is a continuation application, under 35 U.S.C. § 111 (a), of international application No. PCT/KR2023/011520, filed Aug. 4, 2023, which claims priority under 35 U. S. C. § 119 to Korean Patent Application No. 10-2022-0124711, filed Sep. 29, 2022, the disclosures of which are incorporated herein by reference in their entireties.

### TECHNICAL FIELD

The present disclosure relates to an electronic device and a controlling method thereof, and more particularly to, an electronic device capable of identifying a new IoT device and notifying a user terminal device of information about the new IoT device.

### BACKGROUND ART

The Internet of Things (IoT) is an intelligent technology and service that connects all things based on the Internet to interact and communicate information. In recent years, various types of IoT devices have been developed and are rapidly being deployed in homes and businesses.

In order to utilize these IoT devices, users had to register a new IoT device with a service (or server), or set the IoT device to be able to connect to the Internet, etc.

### DISCLOSURE

### Technical Solution

An electronic device according to an embodiment may include a first communication device to perform communication through a first wireless communication scheme, a second communication device to perform communication through a second wireless communication scheme which is different from the first wireless communication scheme, and a processor to control the first communication device such that device information is received from an IoT device that is unregistered.

The processor may be configured to, based on the device information of the IoT device being received through the first wireless communication scheme of the first communication device, control the second communication device to broadcast, through the second wireless communication scheme, notification information including the device information and notifying that there is the IoT device.

A controlling method of an electronic device according to an embodiment may include receiving device information of an IoT device unregistered through a first wireless communication scheme, and broadcasting notification information including the device information and notifying that there is the IoT device through a second wireless communication scheme which is different from the first wireless communication scheme.

An electronic system according to an embodiment may comprise an IoT device, an electronic device, and a user terminal device, wherein the electronic device is configured to, based on device information of an IoT device that is unregistered being received from the IoT device through a first wireless communication scheme, broadcast notification information including the device information and notifying that there is the IoT device that is unregistered, through a second wireless communication scheme which is different from the first wireless communication scheme.

The user terminal device may be configured to, based on the notification information being received through the second wireless communication scheme, display that there is the IoT device that is unregistered.

### DESCRIPTION OF DRAWINGS

The aspects, features and advantages of the embodiments of the present disclosure will become more apparent through the following description with reference to the accompanying drawings.

FIG. 1 is a view illustrating an electronic system according to an embodiment;

FIG. 2 is a block diagram illustrating configuration of an electronic device according to an embodiment;

FIG. 3 is a block diagram illustrating configuration of an electronic device according to an embodiment;

FIG. 4 is a sequence view provided to explain a registration process of a new IoT device according to an embodiment;

FIG. 5 is a view illustrating an example of a user interface window that can be displayed on a user terminal device;

FIG. 6 is a flowchart provided to explain a controlling operation of an electronic device according to an embodiment; and

FIG. 7 is a flowchart provided to explain a controlling operation of a user terminal device according to an embodiment.

### DETAILED DESCRIPTION OF EMBODIMENTS

Hereinafter, various embodiments of the present disclosure will be described with reference to the accompanying drawings. However, it is to be understood that the disclosure is not limited to specific exemplary embodiments, but include all modifications, equivalents, and/or alternatives according to exemplary embodiments of the disclosure. Throughout the description of the accompanying drawings, similar components may be denoted by similar reference numerals.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

The expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element). On the other hand, when an element (e.g., a first element) is referred to as being “directly coupled with/to” or “directly connected to” another element (e.g., a second element), it should be understood that there is no intervening element (e.g., a third element) in-between.

The expression “˜configured (or set) to” used in the disclosure may be replaced by an expression, for example, “suitable for,” “having the capacity to,” “˜designed to,” “˜adapted to,” “˜made to,” or “˜capable of” depending on a situation. The term “˜configured (or set) to” may not necessarily mean “specifically designed to” in hardware. Instead, the expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

Hereinafter, the present invention will now be described in detail with reference to the drawings.

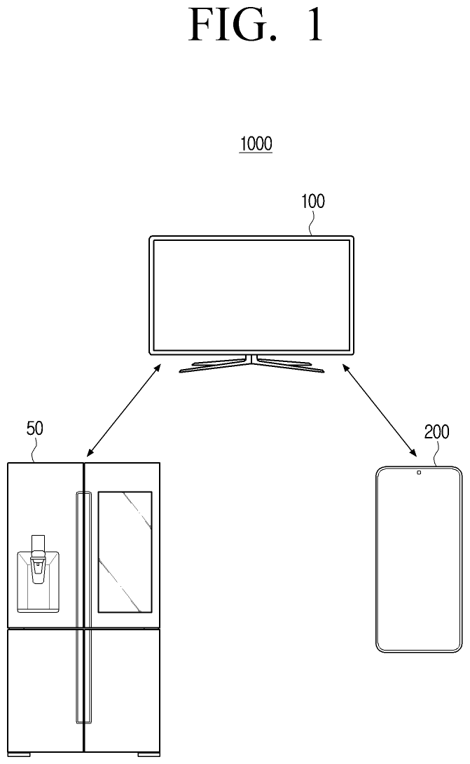

FIG. 1 is a view illustrating an electronic system according to an embodiment.

Referring to FIG. 1, an IoT system 1000 includes a plurality of IoT devices 100, 200. Meanwhile, although the IoT system 1000 illustrated herein includes only two IoT devices 100, 200, in an implementation, the IoT system may include only one IoT device, or may include three or more IoT devices.

Further, the IoT system 1000 may include an IoT server for managing the plurality of IoT devices, which may be located in the same space where the plurality of IoT devices are located, or may be located in an external space separated from the plurality of IoT devices. The IoT server may also serve as one of the IoT devices.

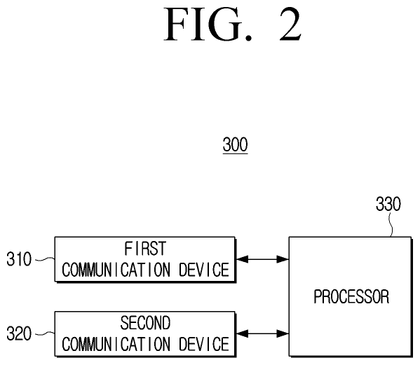

Each of the plurality of IoT devices 100, 200 may be connected to an IoT system to perform a function supported by each device. In addition, each of the plurality of IoT devices 100, 200 may transmit/receive information and control commands necessary to perform the respective functions to/from other IoT devices. The specific configuration and operation of these IoT devices will be described later with reference to FIG. 2.

As described above, the plurality of IoT devices 100, 200 may be located in a particular space. Such a space may be a residential space where a user lives or various spaces such as a work facility, a public institution, etc. Hereinbelow, for convenience of explanation, it is assumed that the corresponding space is a residential space, but depending on an implementation, the present disclosure may be applied to various environments such as offices, government offices, etc.

When a new IoT device 50 is installed in a user's living space as described above, the installed IoT device is not registered with the IoT system 1000. Therefore, registration with the IoT system 1000 or access to the Internet network is required to execute the services of the IoT device 50.

If the new IoT device is a device capable of receiving various types of information such as display, touch, etc. the new IoT device may directly receive various settings for connecting to the IoT system to connect to the IoT system or connect to the Internet environment.

However, if the function for receiving various settings required for connection to the IoT system is not equipped, connection to the IoT system or the Internet environment must be performed with the help of other devices. For this function, each device of the IoT system can support functions such as Easy Setup, onboarding, commissioning, etc. Such a function may be referred to by other expressions than those described above, and the function enables an IoT device to connect to the IoT system or the Internet network with the help of other devices.

For this operation, the new IoT device may transmit a beacon to the surroundings, and other IoT devices that receive the beacon notify the user that there is a new IoT device that can be connected to the user's terminal device or directly, and the user may register the new IoT device through the notification.

This method is highly convenient in that it allows the user to easily register new IoT devices with the IoT environment. However, there are various communication schemes supported by each IoT device, and in the case of mobile devices, due to power consumption issues, new device searches using specific communication schemes are not performed in the background, but only when a specific application is running. Accordingly, there were cases where new IoT devices were not easily recognized on mobile devices.

For convenience of explanation, it is assumed that the first IoT device 100 and the second IoT device 200 support the first and second communication schemes, and that the new IoT device 50 supports only the first communication scheme.

Here, the first communication scheme may be a communication scheme using Wi-Fi, and the second communication scheme may be a communication scheme such as BLE, Bluetooth, or the like. However, the two communication schemes may be different in an implementation, and other communication schemes (e.g., LTE, NR, etc.) may be used in addition to the communication schemes described above.

It is assumed that a second IoT device 200 is a user terminal device (e.g., smartphone, tablet, etc.), i.e., a mobile device. Such a mobile user terminal device supports a search for a new IoT device using the second communication scheme, but a search for a new IoT device using the first communication scheme is generally performed only when an application for search is running. In other words, since Wi-Fi scanning consumes relatively large power, it is generally performed only while the application is running, rather than in the background. However, BLE scanning (i.e., BLE advertising) can be performed in the background.

As such, since the second IoT device 200 supports only BLE scanning until a specific application is operated, and the new IoT device 50 transmits a beacon only through a Wi-Fi scheme (i.e., SoftAP), the second IoT device 200 cannot recognize the new IoT device unless the application for searching new IoT devices is operated.

The present disclosure uses the first IoT device 100 to enable the second IoT device 200 to recognize a new IoT device even in such an environment.

The first IoT device 100 is a device capable of continuously scanning using the first communication scheme. For example, the first IoT device 100 may be a device that is supplied with external power, or a device that does not have any performance problems even when performing scanning using the first communication scheme.

As such, the first IoT device 100 may perform Wi-Fi scanning and thus, may receive a beacon transmitted from the new IoT device 50 in a specific space.

The first IoT device 100 that receives the corresponding beacon may receive device information of the new IoT device 100 through the first communication scheme and broadcast notification information including the received device information through the second communication scheme (e.g., BLE).

As such, since the first IoT device 100 broadcasts notification information through the second communication scheme, the second IoT device 200 may recognize the presence of the new IoT device 50 through BLE scanning which may operate even in the background.

When such a recognition operation is performed, the second IoT device 100 may notify the user that there is a new IoT device available for registration, and may register (or set up) the new IoT device as an available IoT device at the user's request.

As such, in the IoT system according to an embodiment, even when a new IoT device transmits a beacon using a communication scheme in which a user terminal device does not perform scanning in the background, the corresponding user terminal device may recognize the new IoT device through a relay of other IoT devices.

Meanwhile, although FIG. 1 illustrates and describes that there is only one IoT system in one environment, there may be a plurality of IoT systems in one environment, and it is also possible for the plurality of IoT systems to operate in conjunction with each other. For example, an IoT device may be included in each of a plurality of IoT systems.

Meanwhile, although FIG. 1 illustrates and describes that the second IoT device supports both communication schemes, the present disclosure is also applicable to a case where the second IoT device supports only one communication scheme, and the new IoT device operates in another communication scheme which is different from the communication scheme supported by the second IoT device. For example, when the second IoT device supports only a Wi-Fi scheme and the new IoT device is operable only in a BLE scheme, the first IoT device may receive a beacon of the BLE scheme and convert it to the Wi-Fi scheme and transmit it to so that the registration process can be performed.

FIG. 2 is a block diagram illustrating configuration of an electronic device according to an embodiment.

Referring to FIG. 2, an electronic device 300 includes a first communication device 310, a second communication device 320, and a processor 330. Here, the electronic device 300 may be various IoT devices (e.g., various sensors, IP cameras, home appliances (e.g., refrigerators, washing machines, ovens, vacuum cleaners, air conditioners, air purifiers, etc.)) or user terminal devices (e.g., smartphones, tablets, laptops, etc.) that can be connected to IoT devices. In other words, the IoT devices 100, 200 shown in FIG. 1 can be the electronic device of FIG. 2. Here, the user terminal device is described as a device distinct from the IoT device, but the user terminal device may also be an IoT device.

The first communication device 310 and the second communication device 320 may perform communication with an external electronic device. For example, the first communication device 310 may be Wi-Fi (wireless fidelity). The second communication device may be BLE. In the above description, it is assumed that the first communication device is a device that performs communication through the Wi-Fi scheme, and the second communication device is a device that performs communication through the BLE scheme, but in an implementation, two or more wireless communication schemes may be supported, and specific communication schemes may be used in addition to the above-described examples, such as LTE, LTE Advance (LTE-A), New Radio (NR), code division multiple access (CDMA), wideband CDMA (WCDMA), universal mobile telecommunications system (UMTS), Wireless Broadband (WiBro), or Global System for Mobile Communications (GSM), Zigbee, near field communication (NFC), Magnetic Secure Transmission, radio frequency (RF), or body area network (BAN), among others.

The first communication device 310 and the second communication device 320 may transmit a beacon that transmits a signal to an external device from the electronic device 300, and may receive a beacon transmitted from other devices. Here, the beacon may be a beacon indicating a new IoT device, a beacon indicating that an Internet connection is required, or a beacon indicating that registration with an IoT system is required, etc.

The first communication device 310 and the second communication device 320 may also receive device information from other devices, or transmit/receive various information (e.g., serial number, product type, setup ID, network key, GSSID, SSID, pass phrase, algorithm, etc.) for registration of other devices with the IoT system. For example, when the electronic device 300 is a new IoT device of FIG. 1, the first communication device 310 may connect to an Internet network or connect to an IoT system based on the received information. In addition, the first communication device 310 may also perform a P2P communication connection with another electronic device for transmission of the above-described information.

The first communication device 310 and the second communication device 320 may transmit notification information indicating that a new IoT is discovered using a wireless communication scheme that is different from the wireless communication scheme used to search the new IoT. For example, when a beacon is received through the Wi-Fi scheme, the notification information may be transmitted through the BLE scheme. Conversely, when a beacon is received through the BLE scheme, the notification information may be broadcasted through the Wi-Fi scheme.

The first communication device 310 and the second communication device 320 may measure the intensity value of the signal transmitted from the new IoT device. Various measurement values such as RSSI, RSRP, RSRQ, or any combination of the measurement values may be used as the intensity value.

The processor 330 may control the overall operations and functions of the electronic device 300. Specifically, the processor 330 may perform a function corresponding to the electronic device 300 based on stored instructions. For example, when the electronic device 300 is a television, the processor 330 may perform a function corresponding to the television.

During a normal operation, when a preset period or a preset event (e.g., a command to search for an IoT device from an external device, or the execution of an application capable of performing a search for a new IoT device) occurs, the processor 330 may search for the presence of a new IoT device.

For example, when the electronic device 300 is the first IoT device 100 as shown in FIG. 1, both communication schemes may be used to search for the presence of a new IoT device. Meanwhile, when the electronic device 300 is the second IoT device 200 as shown in FIG. 1, only one of the two communication schemes may be used to search for the presence of a new IoT device. Meanwhile, even in the case of the second IoT device, if the user inputs a command to search for a new IoT device, or if the user executes a specific application to register a new IoT device, both communication schemes may be used to search for the presence of a new IoT device.

When the new IoT device 50 is discovered during such a search process as described above, the processor 330 may control the first communication device and/or the second communication device to receive device information of the new IoT device 50. For example, when a beacon transmitted from the new IoT device 50 includes device information, the processor 330 may identify the device information based on the corresponding beacon information. When the device information is not included in the beacon information, the electronic device 300 may control the communication device 310 to perform a connection with the new IoT device, and may receive the device information of the new IoT device through communication with the corresponding device.

For example, when the new IoT device supports the Wi-Fi scheme, the processor 330 may control the communication device 310 to perform a connection with the new IoT device through a Wi-Fi Direct scheme, receive device information through the corresponding communication scheme, and control the communication device 310 to measure the signal intensity value in the process of receiving the device information. Alternatively, when the new IoT device supports the BLE scheme, the processor 330 may control the communication device 310 to perform a connection with the new IoT device through the BLE scheme and receive the device information through the corresponding communication scheme.

As such, when the device information of the new IoT device is obtained, the processor 330 may control the first communication device 310 or the second communication device 320 so that notification information including the received device information is transmitted through a wireless communication scheme which is different from the wireless communication scheme used to obtain the device information described above. For example, when the device information is received through the first communication scheme, the processor 330 may control the second communication device 320 such that the notification information is broadcasted through the second communication scheme.

Meanwhile, the processor 330 may identify the wireless communication scheme of the new IoT device before performing the above-described operations. Specifically, the processor 330 may identify the wireless communication scheme supported by the new IoT device based on the received device information. That is because, for example, when the new IoT device is a device that supports both Wi-Fi and BLE schemes, the electronic device 300 may not need to relay the received device information. In other words, the processor 330 may identify whether the new IoT device supports only one wireless communication scheme, and may perform the operation of relaying the device information of the corresponding new IoT device through the wireless communication scheme that is not supported by the new IoT device.

The processor 330 may also identify whether the new IoT device is a registrable IoT device. Specifically, when the discovered new IoT device is a device that is located in an external space, rather than a user space, it is an unnecessary operation to notify that the corresponding device is registrable. For this identification, the processor 330 may identify the intensity of the signal received from the new IoT device, and identify whether it is an available IoT device based on the signal intensity. In order to confirm this, the electronic device 300 may pre-store various signal intensity threshold values such as minimum and maximum values of the signal intensity.

Meanwhile, such identification may be performed in the first IoT device 100 of FIG. 1, and may also be performed in the second IoT device 200. There may be various implementations, such as the first IoT device 100 identifying whether relaying is necessary before relaying beacon information, the second IoT device 200 identifying whether notifying the user is necessary based on the received information, performing both identification above, not performing any identification, etc.

As such, when the new IoT device is identified as an available device, the processor 330 may perform a process to register the corresponding IoT device. For example, when the electronic device 300 includes a display, the processor 300 may control the display to display information that a new IoT is discovered and is available for registration.

Here, whether a display is included may include not only a case where the display of the electronic device 300 is not included but also a case where a display that is difficult to display information that a new IoT device is discovered from a user is included even if the display is included, a case where an interface structure that is difficult to receive a selection for registration from the user is included even if the information is displayed, etc. The above describes only displaying the above-described notification in a display method, but in an implementation, the above-described notification may be performed as a sound and the user's command may also be input by the user's voice.

When the electronic device 300 or other device receives a command to proceed with the registration process for a new IoT device, the processor 330 may control the first communication device 310 or the second communication device 320 to transmit information necessary for the new IoT device to connect to an IoT environment or an Internet network in order to register the new IoT device.

As described above, even when a new IoT device transmits a beacon using only a communication scheme that does not scan a user terminal device in the background, the electronic device 300 according to an embodiment may recognize the new IoT device.

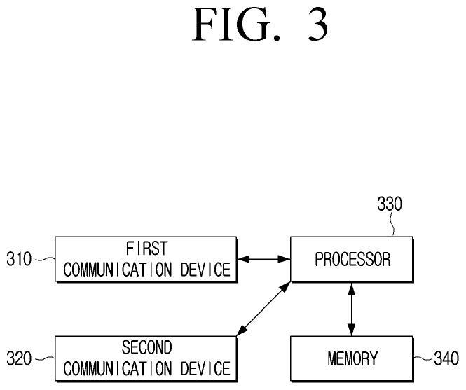

Meanwhile, although FIG. 3 illustrates and describes only a basic configuration of the electronic device 300 (the first communication device 310, the second communication device 320, and the processor 330), the electronic device 300 may further include configurations that are necessary to perform the functions of the corresponding electronic device in addition to the configurations described above. For example, when the electronic device 300 is a refrigerator, the electronic device 300 may further include configurations related to built-in functions, when the electronic device 300 is a washing machine, configurations related to washing machine functions, when the electronic device 300 is a CCTV, configurations related to a camera, when the electronic device 300 is a television, configurations related to a broadcast signal receiving module and a display, and so on.

FIG. 3 is a block diagram illustrating configuration of an electronic device according to an embodiment.

Referring to FIG. 3, the electronic device 300 may include the first communication device 310, the second communication device 320, the processor 330, and a memory 340.

The configurations of the first communication device 310, the second communication device 320, and the processor 330 have been described above with reference to FIG. 2, so the memory 340 will be described below.

The memory 340 may store instructions or data related to at least one other component of the electronic device 300. In particular, the memory 340 may be implemented as non-volatile memory, volatile memory, flash memory, a hard disk drive (HDD), a solid state drive (SSD), etc. The memory 340 may be accessed by the processor 140, and data reading/writing/modifying/deleting/updating can be performed by the processor 330. In the present disclosure, the term ‘memory’ may include the memory 340, a ROM (not shown) in the processor 330, a RAM (not shown), or a memory card (not shown) (e.g., a micro SD card, a memory stick) mounted on the electronic device 300. In addition, programs and data for configuring various screens to be displayed on the display area of the display may be stored in the memory 340.

The memory 340 stores location information of the electronic device 300. Here, the location information refers to information about the space in which the electronic device is currently located in the user's space. For example, in the case of a refrigerator, the location information may be the kitchen in which the refrigerator is located (or an identification number corresponding to the kitchen). Such a location may be information that was entered by the user during the installation process of the corresponding electronic device.

Alternatively, when the electronic device 300 is a mobile device, the location information of the IoT device with the strongest signal intensity is received by transmitting/receiving signals between currently registered IoT devices, which may be the location information received from the corresponding IoT device.

The memory 340 may store information about the signal intensity. Specifically, the memory 340 may store threshold value information for signal intensity, which is a criterion for identifying whether a new IoT device is an available device.

In addition, the memory 340 may store information about an unregistered device. Specifically, there may be a case where a user is notified of a new IoT device, but the user declines to register the new IoT device. In this case, the electronic device 300 may store information about the device that the user has declined to register, and when a beacon is received from the corresponding device, the electronic device 300 may not perform the above-described relaying operation (or notification operation) since it is not necessary to continuously notify the user about the device that the user has declined to register, even though the user has identified the presence of the new IoT device.

The memory 340 may store various instructions, programs, applications, and the like necessary to perform the functions of the electronic device 300. One of these applications may be for managing an IoT system or running services of the IoT device.

Meanwhile, while FIGS. 2 and 3 illustrate that the first communication device and the second communication device are separate configurations, the two communication devices may be configured as one configuration (or module) if they support only two or more different wireless communications.

The difference in the wireless communications described above may also be distinguished by the difference in communication algorithms (communication schemes), and may also be distinguished by the frequency bands used by the wireless communications. For example, the above-described relaying operation may be applied even when the new IoT device can use only Wi-Fi signals in the 5G band and the user terminal device can use only Wi-Fi signals in the 2.5G band.

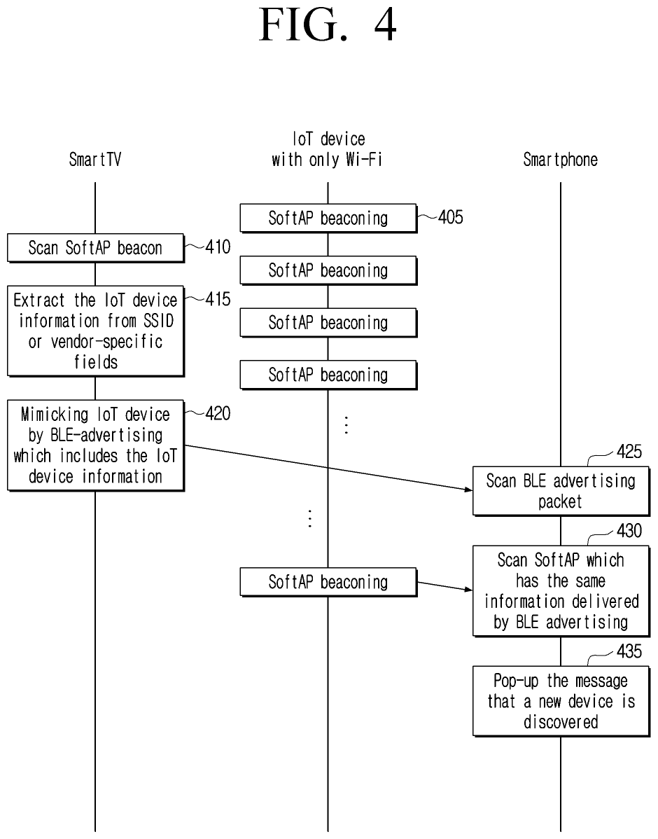

FIG. 4 is a sequence view provided to explain a registration process of a new IoT device according to an embodiment.

FIG. 4 assumes a case in which the new IoT device 50 is installed in an environment where two pre-registered IoT devices 100, 200 are located. In addition, as previously assumed, it is assumed that the new IoT device 50 supports only the first communication scheme (e.g., Wi-Fi), the first IoT device 100 supports both the first communication scheme and the second communication scheme, and the second IoT device 200 supports both the first communication scheme and the second communication scheme, but performs scanning using only the second communication scheme in the background. Meanwhile, the above-described communication schemes are exemplary, and in an implementation, communication schemes other than the above-described wireless communication schemes may be applied.

When the new IoT device 50 is not registered with an IoT server or the like, SoftAP may be turned on, and a beacon may be transmitted to neighboring devices (405). Such beacon transmission may be performed periodically until registration.

In this case, the transmitted beacon may include whether onboarding is required, information that registration with the IoT system such as the onboarding scheme is required, information for identifying a device, such as the device name, SSID, MAC address, etc., the device type, information about supported network (setup Available Network), etc.

The first IoT device 100 may periodically search for the presence of a new IoT device (410), and when the new IoT device 50 is identified during the search process, the first IoT device 100 may receive device information from the new IoT device (415). Specifically, the new IoT device 50 may transmit a beacon using the Wi-Fi scheme, and the first IoT device 100 may receive the beacon using the first wireless communication scheme.

Meanwhile, since the second IoT device 200 does not perform Wi-Fi scanning in the background, the second IoT device 200 cannot receive the beacon transmitted from the new IoT device 50.

The first IoT device 100 that receives the beacon may identify the device information of the new IoT device, and identify whether it is necessary to relay the identified device information. Specifically, this is because, when the new IoT device supports both the first communication scheme and the second communication scheme, the first IoT device 100 may not need to relay the device information. For example, the first IoT device 100 may identify whether relaying for the received beacon is required by using the value of “setup Available Network” in the received beacon. Specifically, when the network field value of the new IoT device has a value that supports only Wi-Fi, it is determined that the relaying operation is required, and when the network field value of the new IoT device has a value that supports both Wi-Fi and BLE, the relaying operation may not be performed.

The first IoT device 100 may then identify from the information included in the received beacon whether onboarding is required and information that registration with the IoT system such as the onboarding scheme is required to identify whether beacon relaying for the corresponding new IoT device is required. In other words, when it is identified that onboarding is not required based on the received beacon, the first IoT device 100 may not perform relaying for the received beacon.

When it is identified that the new IoT device 50 does not support the second wireless communication scheme, the first IoT device 100 may broadcast notification information including the received device information to neighboring devices through the second wireless communication scheme (420). Specifically, the first IoT device 100 may generate and transmit notification information that includes all of the received beacon information, or may generate and broadcast notification information using only some of the received beacon information (e.g., the new IoT device's SSID or MAC address, serial number, whether onboarding is required, and how onboarding is performed).

As such, when the notification information is broadcasted through the second wireless communication scheme, the second IoT device 200 scanning the second wireless communication scheme may receive the corresponding notification information (425). For example, the above-described notification information may be received through the BLE scanning scheme.

The second IoT device 200 that receives the corresponding notification information may identify the presence of the new IoT device, and may perform the operation for the registration process accordingly (435).

Prior to the registration process described above, the second IoT device may identify the device information of the new IoT device, and identify the communication scheme supported by the new IoT device from the identified device information. When the identified communication scheme is the first wireless communication scheme, the second IoT device may directly receive the beacon transmitted from the new IoT device via the SoftAP function (430). Such an operation of receiving the beacon is to perform verification or to identify the signal intensity of the new IoT device, which may be omitted in an implementation.

When the presence of the new IoT device is identified or verified, the second IoT device 200 may display a message indicating the presence of the new IoT device to the user (435). Subsequently, when there is a confirmation command from the user, the process of setting (registering) the corresponding new IoT device as an available IoT device may be performed.

Meanwhile, in an implementation, the signal intensity of the new IoT device may be identified prior to the above-described message display operation, and whether the new IoT device is a registrable IoT device may be verified based on the identified signal intensity. For example, when the received signal intensity is less than a preset signal intensity, the notification operation described above may not be performed.

Meanwhile, in an implementation, the notification operation may be omitted by setting the IoT device as an available device immediately without notifying the user.

Meanwhile, the above implementation describes that the second device performs the registration process, but it may also be implemented in such a way that the second device only performs the user confirmation operation, and the operation of setting up the new IoT device in the IoT system is performed by the first IoT device 100.

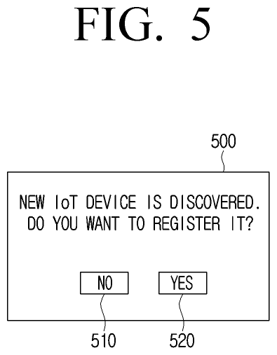

FIG. 5 is a view illustrating an example of a user interface window that can be displayed on a user terminal device.

Referring to FIG. 5, a user interface window 600 is illustrated. The user interface window 600 may include information that a new IoT device is discovered, and may include areas 510, 520 for confirming whether the new IoT device is registered. For example, the user interface window 600 may be displayed on the second IoT device 200 of FIG. 1.

Meanwhile, in the illustrated example, only the information that a new IoT device is discovered is displayed, but in an implementation, the specific device information of the new IoT device may also be displayed.

The user may select an confirmation area 520 in a user interface window 500 described above. When the confirmation area 520 is selected, the electronic device 300 may perform a process for registering the discovered new IoT device. For example, the electronic device 300 may transmit Internet access information for the new IoT device to access an external Internet or the like, and may perform the operations of registering the new IoT device with the IoT system. Meanwhile, in an implementation, the information that the user confirmation has been made may be transmitted to the device that relayed the beacon information so that the actual registration process can be performed in the device that relayed the beacon information.

Since a general user terminal device does not perform Wi-Fi scanning in the background, it cannot receive a beacon through the Wi-Fi manner and thus, cannot recognize a new IoT device. However, according to the present disclosure, the first IoT device 100 relays and transmits the beacon received from the new IoT device through the wireless communication scheme that can be scanned by the user terminal device and thus, the user terminal device can recognize the new IoT device even if it does not perform Wi-Fi scanning in the background.

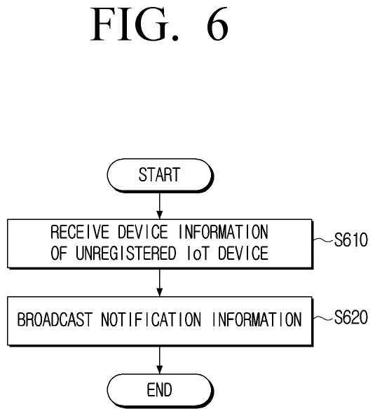

FIG. 6 is a flowchart provided to explain a controlling operation of an electronic device according to an embodiment.

Referring to FIG. 6, the device information of an unregistered IoT device is received through the first wireless communication scheme (S610). For example, a beacon transmitted from the unregistered IoT device may be received through the Wi-Fi scheme (or SoftAP).

Subsequently, notification information including the device information and indicating the presence of the unregistered IoT device is broadcasted through the second wireless communication scheme that is different from the first wireless communication scheme (S620). In this case, the notification information may include at least one of SSID, MAC address, or serial number of the unregistered IoT device, and may include information on whether onboarding is required or information on how to onboard. For example, a beacon received through the Wi-Fi scheme may be broadcasted through the BLE scheme. In this case, the broadcasted notification information may include all of the information included in the received beacon or only some of the information.

Meanwhile, in an implementation, it may be determined whether the notification information needs to be relayed before broadcasting. Such determination can be made in two ways. The first is whether the new IoT device supports the second wireless communication scheme. This is because, for example, if the new IoT device can operate through not only the first wireless communication scheme but also the second wireless communication scheme, relaying it is unnecessary. The second is to identify whether the new IoT device is an available device. This is because, for example, if the new IoT device is a device located in an external space other than the user space, the relaying operation described above is also unnecessary. To this end, the electronic device may identify the intensity of the signal transmitted from the new IoT device, and compare the identified signal intensity with a preset signal intensity. When the signal intensity is less than the preset signal intensity, the relaying operation described above may be omitted.

As described above, according to the controlling method of the electronic device, even when the new IoT device transmits a beacon using only a communication scheme in which scanning is not performed in the background, the beacon is relayed and transmitted such that the corresponding beacon is scanned by the user terminal device, so the new IoT device can be recognized by the user terminal device. The controlling method described above may be performed on devices such as the IoT device 200 of FIG. 1, as well as electronic devices such as those shown in FIG. 2 or 3.

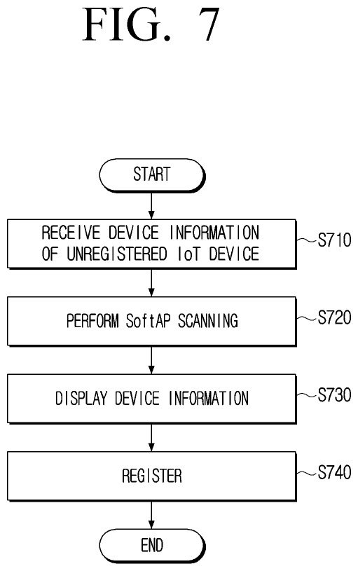

FIG. 7 is a flowchart provided to explain a controlling operation of a user terminal device according to an embodiment.

Referring to FIG. 7, a user terminal device may perform communication using the first wireless communication scheme and the second wireless communication scheme, and may perform a search for a new IoT device using the second wireless communication scheme.

In this case, a beacon indicating the presence of an unregistered IoT device may be received through the second wireless communication scheme (e.g., BLE) (S710).

When the beacon is received, the corresponding device information can be displayed to indicate that a new IoT device is discovered (S730).

Meanwhile, in an implementation, SoftAP scanning may be performed prior to the display operation described above to directly receive a beacon from the new IoT device (S720). For example, in the case of a new IoT device that does not require registration, a verification process may be performed in that unnecessary notification causes inconvenience to the user. For example, when a new IoT device discovered by another device is a device that is not discovered in the space where the user is currently located (a new IoT in the neighbor's house), a beacon may be received directly from the new IoT device through SoftAP scanning to identify a case where the user is currently not located in the corresponding space, etc. In this case, the process of measuring the signal intensity between new IoT devices may be performed.

The above operation can be performed in two ways. The first method is that when a new IoT device is discovered through the BLE scheme, an application for identifying and verifying the new IoT device is operated, and SoftAP scanning is performed through the operation of the corresponding application. The second method is that when a new IoT device is discovered through the BLE scheme, SoftAP scanning is performed, and when the new IoT device is identified through the Soft scanning, the above-described application is operated.

When the above verification process also confirms that the IoT device is a device needs to be registered, it can be displayed that registration of the new IoT device is possible.

Then, when a command to proceed with the registration process is input from the user, the process of registering the new IoT device may be performed.

Subsequently, when the IoT device is an available IoT device, the IoT device is set as an available IoT device. Specifically, the setting operation can be manual or automatic. For example, when an unregistered device is set to be registered automatically, the corresponding IoT device can be set as an available IoT device without user confirmation.

When user confirmation is required, and the current electronic device is a device including a display, it may be displayed that registration for the IoT device is possible (S730).

When the user completes a confirmation operation for such a notification, the electronic device may transmit to the IoT device at least one of information required to connect to the Internet or information required to connect to an IoT server (S740).

As such, the controlling method according to the present embodiment may search for a new IoT device that transmits a beacon only through a particular scheme, even without scanning a particular wireless communication scheme with high power consumption in the background.

Meanwhile, terms “˜er/or” or “module” used in the disclosure may include units configured by hardware, software, or firmware, and may be used compatibly with terms such as, for example, logics, logic blocks, parts, circuits, or the like. The “˜er/or” or “module” may be an integrally configured part or a minimum unit performing one or more functions or a part thereof. For example, the module may be configured by an application-specific integrated circuit (ASIC).

Various embodiments according to the present may be implemented in software including an instruction stored in a machine-readable storage medium (e.g., computer). The machine may be a device that invokes the stored instruction from the storage medium and is operated based on the invoked instruction, and may include an electronic apparatus (e.g., electronic device 300) according to embodiments disclosed herein. In case that the instruction is executed by the processor, the processor may directly perform a function corresponding to the instruction or other components may be used to perform the function corresponding to the instruction under control of the processor. The instruction may include codes provided or executed by a compiler or an interpreter. Here, the term ‘non-transitory’ means that the storage medium is tangible without including a signal, and does not distinguish whether data are semi-permanently or temporarily stored in the storage medium.

According to an embodiment, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as a memory of a server of a manufacturer, a server of an application store, or a relay server or be temporarily generated.

The components (e,g., modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

1. An electronic device, comprising:
a first communication device to perform communication through a first wireless communication scheme;
a second communication device to perform communication through a second wireless communication scheme which is different from the first wireless communication scheme; and
a processor to control the first communication device such that device information is received from an Internet of Things (IoT) device that is unregistered, wherein the processor is configured to:
based on the device information of the IoT device being received through the first wireless communication scheme of the first communication device, control the second communication device to broadcast, through the second wireless communication scheme, notification information including the device information and notifying that there is IoT device that is unregistered.

2. The electronic device as claimed in claim 1, wherein the notification information includes at least one of SSID, MAC address or serial number of the IoT device, and includes information about whether onboarding is required or how onboarding is performed.

3. The electronic device as claimed in claim 1, wherein the processor is configured to identify whether the IoT device supports the second wireless communication scheme using the device information, and based on the second wireless communication scheme being unsupported by the IoT device, control the second communication device to broadcast the notification information.

4. The electronic device as claimed in claim 1, wherein the processor is configured to control the first communication device to identify a signal intensity of the IoT device, identify whether the IoT device is available based on the identified signal intensity, and based on identifying that the IoT device is the available, control the second communication device to broadcast the notification information.

5. The electronic device as claimed in claim 1, wherein the first wireless communication scheme is a Wi-Fi scheme; and
wherein the second wireless communication scheme is a BLU or a Bluetooth scheme.

6. A controlling method of an electronic device, the controlling method comprising:
receiving device information of an IoT device that is unregistered through a first wireless communication scheme; and
broadcasting notification information including the device information and notifying that there is the IoT device through a second wireless communication scheme which is different from the first wireless communication scheme.

7. The controlling method as claimed in claim 6, wherein the notification information includes at least one of SSID, MAC address or serial number of the IoT device, and includes information about whether onboarding is required or how onboarding is performed.

8. The controlling method as claimed in claim 6, further comprising:
identifying whether the IoT device supports the second wireless communication scheme using the device information.

9. The controlling method as claimed in claim 6, wherein the electronic device is further configured to:
identify a signal intensity of the IoT device; and
identify whether the IoT device is an available IoT device based on the identified signal intensity.

10. The controlling method as claimed in claim 6, wherein the first wireless communication scheme is a Wi-Fi scheme; and
wherein the second wireless communication scheme is a BLU or a Bluetooth scheme.

11. An electronic system, comprising:
an IoT device that is unregistered;
a user terminal device; and
an electronic device configured to:
based on device information of the IoT device being received from the IoT device through a first wireless communication scheme, broadcast notification information including the device information and notifying that there is an IoT device through a second wireless communication scheme which is different from the first wireless communication scheme; and
wherein the user terminal device is configured to, based on the notification information being received through the second wireless communication scheme, display information that there is an IoT device that is unregistered.

12. The electronic system as claimed in claim 11, wherein the user terminal device is configured to, based on the notification information being received through the second wireless communication scheme, receive device information from the IoT device by performing SoftAP of the first wireless communication scheme.

13. The electronic system as claimed in claim 11, wherein the user terminal device is configured to set the IoT device as being available IoT based on the device information.
